(19) United States
(12) Patent Application Publication
(10) Pub. No.: US 2024/0275113 A1
(43) Pub. Date: Aug. 15, 2024

(54) Shaft-Grounding Device for Establishing an Electrically Conductive Connection Between a Rotatable Shaft and a Housing

(71) Applicant: ZF Friedrichshafen AG, Friedrichshafen (DE)

(72) Inventors: Michael Griesbach, Tettnang (DE); Dominik Erny, Friedrichshafen (DE)

(21) Appl. No.: 18/568,086

(22) PCT Filed: May 13, 2022
(86) PCT No.: PCT/EP2022/063032

§ 371 Date: Dec. 7, 2023

(30) Foreign Application Priority Data
Jun. 8, 2021 (DE) 10 2021 205 762.4
Sep. 10, 2021 (DE) 10 2021 210 011.2

(51) Int. Cl. H01R 39/12; B60K 1/00; H01R 4/64; H02K 11/40

(52) U.S. Cl. CPC H01R 39/12; B60K 1/00; H01R 4/643; H02K 11/40; B60K 2001/001

(57) ABSTRACT

A shaft grounding device for establishing an electrically conductive connection between a rotatable shaft and a housing is mechanically and electrically connected to the housing. The shaft grounding device particularly includes contact elements, where each of the contact elements is elastically bendable and electrically conductive, and where the contact elements forming a sliding contact that is electrically conductive with a circumferential surface of the rotatable shaft or a sleeve on the rotatable shaft, with the the contact elements preloading the sliding contact. Additionally, the shaft grounding device includes at least one guide element, with each of the at least one guide element preventing the contact elements from folding over when the shaft grounding device is mounted onto the rotatable shaft.

### CROSS-REFERENCE TO RELATED APPLICATION

The present application is related and has right of priority to German Patent Application No. 10 2021 205 762.4 filed on Jun. 8, 2021 and German Patent Application No. 10 2021 210 011.2 filed on Sep. 10, 2021, and is a nationalization of PCT/EP2022/063032 filed in the European Patent Office on May 13, 2022, both of which are incorporated by reference in their entirety for all purposes.

### FIELD OF THE INVENTION

The invention relates generally to a shaft grounding device for establishing an electrically conductive connection between a rotatable shaft and a housing. The invention further relates generally to a transmission for a motor vehicle having such a shaft grounding device, to an electric axle drive unit for a motor vehicle having such a shaft grounding device, and to an electric machine having such a shaft grounding device.

### BACKGROUND

DE 10 2016 010 926 A1 describes a shaft grounding ring for dissipating induced voltages from a shaft into a machine element. The shaft grounding ring has a housing and multiple discharge elements arranged on the housing. An elastically bent edge region of each of the discharge elements rests on the shaft, such that an electrically conductive sliding contact with the shaft is formed.

When the shaft grounding ring is mounted onto the shaft, individual discharge elements may fold over. This negatively affects the preload force of the discharge elements and, thereby, reduce the service life of the shaft grounding ring. This is undesirable.

### SUMMARY OF THE INVENTION

The problem addressed by the invention is therefore that of providing a shaft grounding device which prevents damage to the sliding-contact-guiding elements during the mounting process.

As the solution to the problem, the invention relates to a shaft grounding device for establishing an electrically conductive connection between a rotatable shaft and a housing. The shaft grounding device is mechanically and electrically connected to the housing and has multiple elastically bendable and electrically conductive contact elements. The contact elements are formed, for example, by brushes or by polytetrafluoroethylene (PTFE) elements having electrically conductive fillers or by an electrically conductive nonwoven fabric. The contact elements form an electrically conductive sliding contact with a circumferential surface of the shaft or with a sleeve which has been placed onto the shaft. The contact elements are arranged and designed such that, due to their inherent bending elasticity, they bring about a preloading of the sliding contact.

According to the invention, the shaft grounding device has at least one guide element. The guide element prevents contact elements from folding over when the shaft grounding device is mounted onto the shaft. The invention is based on the finding that damage to the contact elements during the process of mounting onto the shaft is frequently due to a non-coaxial arrangement of the shaft and the shaft grounding device. Due to the guide element, precisely this non-coaxial-arrangement state is limited to an extent that is safe for the contact elements.

The contact elements are preferably arranged in the shape of a ring. In other words, the contact elements are arranged along the circumferential surface of the shaft or the sleeve and, in this way, form a ring. One guide element is arranged at each of at least three positions along this ring-shaped arrangement and, in fact, between one contact element and the next, in other words between a respective pair of circumferentially adjacent contact elements. Due to the three guide elements, the shaft grounding device is centered along the circumferential surface of the shaft or the sleeve during the process of mounting onto the shaft, thereby preventing contact elements from folding over during the mounting process.

According to one alternative embodiment, the at least one guide element is ring-shaped, such that an annular gap is formed between the outer diameter of the shaft (or the sleeve on the shaft) and the inner diameter of the guide element during the process of mounting on the shaft. The contact elements are also arranged in the shape of a ring in this embodiment. Due to the guide element being ring-shaped, an axial overlap with the inner ends of the contact elements is achieved. As a result, not only are contact elements prevented from folding over, but also a bending load of the contact elements counter to the intended bending direction is limited. This is the case because, when the shaft grounding device is mounted counter to the target alignment, the contact elements are bent only up to the point at which they stop at the guide elements, due to the axial overlap.

Preferably, the contact elements are fastened between a holding element and a clamping element. In such an embodiment, the at least one guide element is either formed directly on, or is fastened to, the holding element or the clamping element. The contact elements are easily and reliably fastened between the holding element and the clamping element. The formation or fastening of the at least one guide element on one of these elements is easy to implement, such that the effect of protecting the contact elements against folding over is provided with only a small amount of additional effort.

Preferably, at least some of the contact elements have a cross-section which increases radially inwardly, such that there is an axial overlap of at least one such contact element and the at least one guide element. A bending load of the contact elements counter to the intended bending direction is limited in this way as well. This is the case because, when the shaft grounding device is mounted counter to the target alignment, the contact elements, due to their wide base cross-section, stop at the at least one guide element.

Preferably, the holding element or the clamping element has a recess for one of the contact elements. As a result, a sufficiently large bend radius of the contact elements is ensured despite the axial overlap with the at least one guide element.

According to one preferred embodiment, at least one of the contact elements encompasses the at least one guide element. As a result, the affected contact element has a wide support base despite the at least one guide element, such that a uniform contact pressure on the circumferential surface of the shaft or the sleeve is achieved. This improves the service life of the shaft grounding device. In addition, due to such an embodiment, the contact elements are prevented from folding over in the event of faulty mounting.

Preferably, at least each contact element which encompasses the at least one guide element has a recess. The at least one guide element is arranged such that it passes through the recess. Such an embodiment not only prevents the contact elements from folding over in the event of faulty mounting, but rather also facilitates the assembly of the shaft grounding device. In addition, a particularly rigid design of the contact elements is possible, such that an overload of the contact elements due to a reversal of the direction of rotation of the shaft is ruled out.

According to one preferred embodiment, the at least one guide element has no contact with the circumferential surface of the shaft or the sleeve when the shaft grounding device is in the mounted state. As a result, unnecessary losses due to friction are avoided.

The shaft grounding device according to the invention is an integral part of a transmission for a motor vehicle, for example, an automatic transmission or an automated transmission having multiple gear steps. The correspondingly grounded shaft of the transmission is rotatably mounted in a housing of the transmission. The shaft is, for example, an output shaft of the transmission. The transmission includes an electric machine for driving the shaft.

The shaft grounding device according to the invention is an integral part of an electric axle drive unit for a motor vehicle. The correspondingly grounded shaft of the electric axle drive unit is rotatably mounted in a housing of the electric axle drive unit.

The shaft grounding device according to the invention is an integral part of an electric machine which includes a rotationally fixed stator and a rotatably mounted rotor. The rotor is coupled to a rotor shaft. The rotor shaft is grounded with respect to a housing of the electric machine by the shaft grounding device according to the invention.

### BRIEF DESCRIPTION OF THE DRAWINGS

Exemplary embodiments of the invention are described in detail with reference to the figures, wherein:

FIG. 1 and FIG. 2 each show a drive train of a motor vehicle;

FIG. 3 shows an electric machine;

FIG. 4 shows a detailed view of a shaft projecting out of a housing;

FIG. 5 shows a top view of a shaft grounding device;

FIG. 6 and FIG. 7 each show a detailed view of a shaft grounding device;

FIG. 8 shows a detailed sectional view of a shaft grounding device together with a shaft and a housing; and

FIG. 9 and FIG. 10 each show a detailed view of a shaft grounding device.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

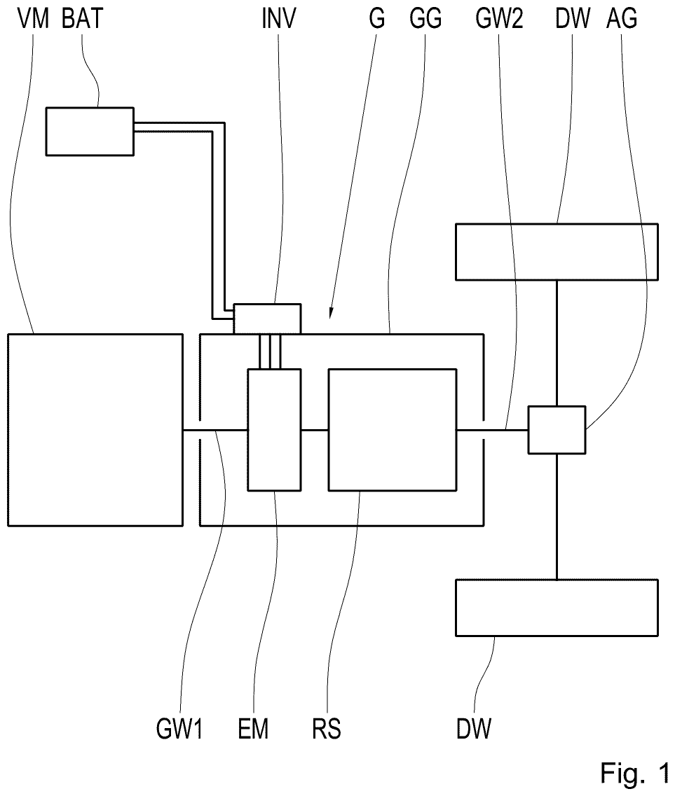

FIG. 1 schematically shows a drive train for a motor vehicle. The drive train includes an internal combustion engine VM, the output of which is connected to an input shaft GW1 of a transmission G. An output shaft GW2 of the transmission G is connected to a differential gear AG. The differential gear AG distributes the power applied at the output shaft GW2 to driving wheels DW of the motor vehicle. The transmission G has a gear set RS, which, together with shift elements not shown in FIG. 1, provides different transmission ratios between the input shaft GW1 and the output shaft GW2. The gear set RS is enclosed in a housing GG which also accommodates an electric machine EM which is connected to the input shaft GW1. The electric machine EM drives the input shaft GW1. A power inverter INV is attached to the housing GG. The power inverter INV is connected to the electric machine EM at one side and to a battery BAT at the other side. The power inverter INV is utilized for converting the direct current of the battery BAT into an alternating current which is suitable for operating the electric machine EM and, for this purpose, includes several power semiconductors. The conversion between direct current and alternating current takes place by a pulse-like operation of the power semiconductors controlled by an open-loop system.

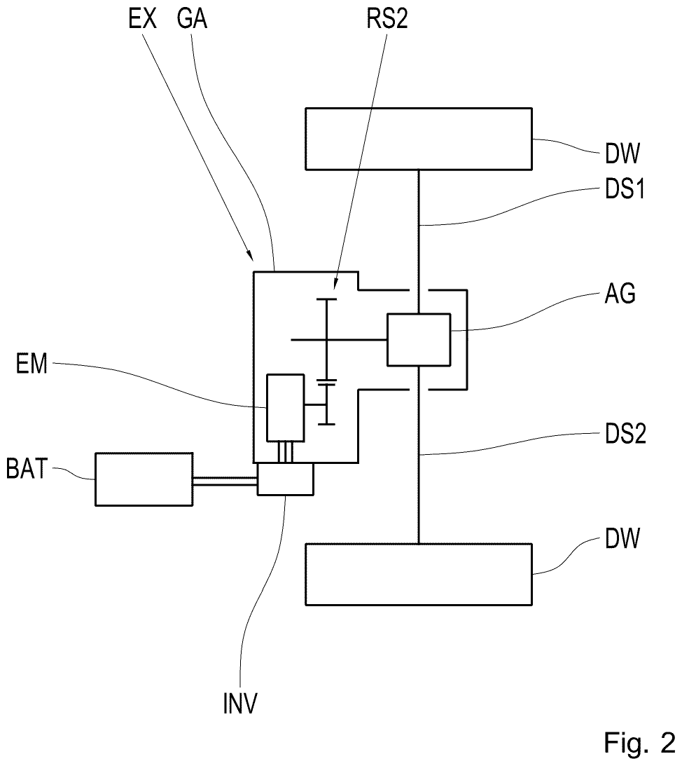

FIG. 2 schematically shows a drive train for a motor vehicle, which, in contrast to the embodiment shown in FIG. 1, is a purely electric drive train. The drive train includes an electric axle drive unit EX. The electric axle drive unit EX includes an electric machine EM, the power of which is transmitted via a reduction gear set RS2 and a differential gear AG onto driving wheels DW of a motor vehicle. Output shafts DS1, DS2 of the differential gear AG are connected to the driving wheels DW. The electric machine EM, the reduction gear set RS2, and the differential gear AG are enclosed in a housing GA. A power inverter INV is attached to the housing GA. The power inverter INV is connected to the electric machine EM at one side and to a battery BAT at the other side. The power inverter INV is utilized for converting the direct current of the battery BAT into an alternating current which is suitable for operating the electric machine EM and, for this purpose, includes several power semiconductors. The conversion between direct current and alternating current takes place by a pulse-like operation of the power semiconductors controlled by an open-loop system.

The drive trains shown in FIG. 1 and FIG. 2 are to be considered merely as examples.

Due to the pulse-like operation of the power semiconductors, electromagnetic interference signals arise, which, for example, are coupled into the output shaft GW2 in the drive train according to FIG. 1 or into the output shafts DS1, DS2 in the drive train according to FIG. 2. Due to the mounting of the output shaft GW2 and of the output shafts DS1, DS2, which is not shown in FIG. 1 and FIG. 2, the output shaft GW2 and the output shafts DS1, DS2 are electrically insulated with respect to the housing GG and the housing GA, respectively, since the lube oil in the interior of the housing GG, GA has electrically insulating properties. Therefore, interference signals coupled into the output shaft GW2 or into the output shafts DS1, DS2 cannot flow on a short path into the housing GG or into the housing GA, respectively, with the respective housing, in turn, being connected to an electrical ground of the motor vehicle. Instead, the interference signals return to the electrical ground by electromagnetic emission, as the result of which other electronic components of the motor vehicle are interfered with. The output shaft GW2 or the output shafts DS1, DS2 protruding from the housing GG or the housing GA, respectively, form an antenna which facilitates the electromagnetic emission of the interference signals.

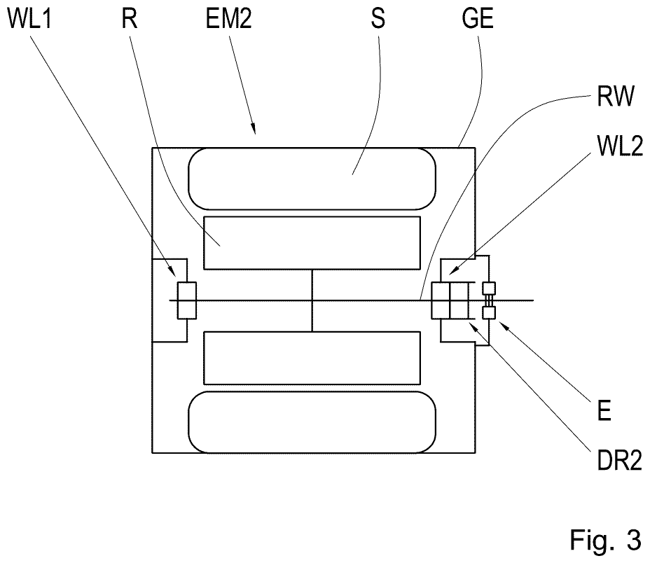

FIG. 3 shows a schematic view of an electric machine EM2. The electric machine EM2 has a housing GE which accommodates a stator S and a rotor R. The stator S is non-rotatably fixed in the housing GE. The rotor R is coupled to a rotor shaft RW, the rotor shaft RW being rotatably mounted via two roller bearings WL1, WL2 which are supported on the housing GE. One end of the rotor shaft RW projects out of the housing GE. A shaft grounding device E is provided on an exposed section of the rotor shaft RW. A sealing ring DR2 is provided between the roller bearing WL2 and the shaft grounding device E. The shaft grounding device E establishes an electrically conductive contact between the housing GE and the rotor shaft RW. For this purpose, the shaft grounding device E includes brushes or other electrically conductive contact elements which slide on a surface of the rotor shaft RW. A potential difference between the housing GE and the rotor shaft E is reduced via the shaft grounding device E. As a result, the roller bearings WL1, WL2 are protected against an uncontrolled potential equalization via the rolling elements of the roller bearings WL1, WL2.

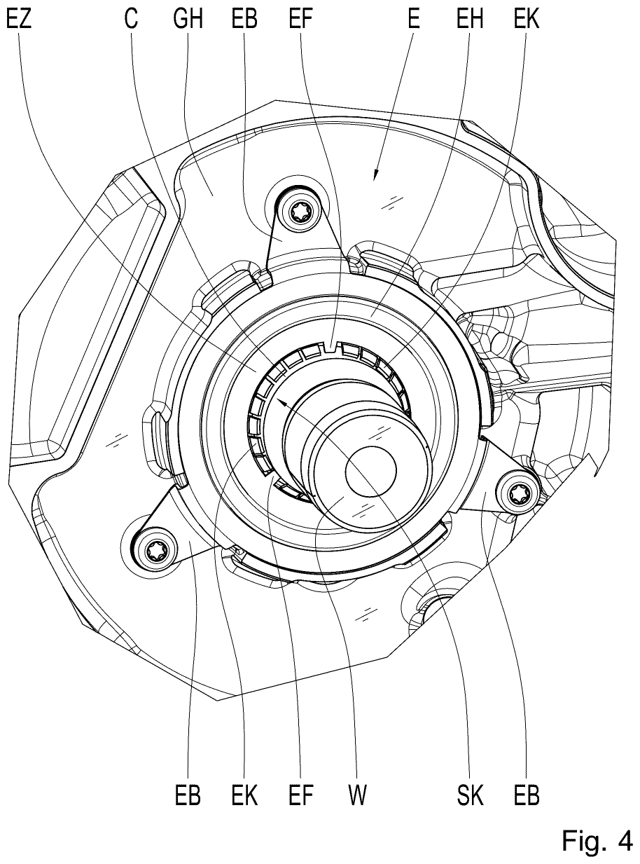

FIG. 4 shows a detailed view of a shaft W according to a first exemplary embodiment projecting out of a housing GH. The shaft W shown in FIG. 4 could be, for example, the output shaft GW2 according to FIG. 1, one of the output shafts DS1, DS2 according to FIG. 2, or the rotor shaft RW according to FIG. 3. The housing GH could be, for example, the housing GG according to FIG. 1, the housing GA according to FIG. 2, or the housing GE according to FIG. 3. A shaft grounding device E is provided for grounding the shaft W with respect to the housing GH. The shaft grounding device E is ring-shaped and encompasses a circumferential surface C of the shaft W. The shaft grounding device E has a holding element EH on which three fastening tabs EB are formed. Via the fastening tabs EB, the shaft grounding device E is bolted to the housing GH, such that the shaft grounding device E is fixed with respect to the housing GH. Due to the bolted connection with the housing GH, an electrically conductive contact between the holding element EH and the housing GH is also established.

The shaft grounding device E has contact elements EK which are arranged around the circumferential surface C of the shaft W. The contact elements EK are clamped between the holding element EH and a clamping element EZ and are thereby held in position. The radially inner ends of the contact elements EK slide on the circumferential surface C of the shaft W, such that an electrically conductive sliding contact SK is formed. The contact elements EK are made of an electrically conductive material and are electrically conductively connected to the holding element EH. The sliding contact SK allows the contact elements EK to directly contact the shaft W or, alternatively, to a sleeve which has been placed onto the shaft W.

For mounting, the shaft grounding device E is slid in the axial direction onto the circumferential surface C of the shaft W. If there is a non-coaxial alignment of the shaft W and the shaft grounding device E, individual contact elements EK fold over. In order to prevent this, guide elements EF are provided, which are formed on the clamping element EZ. In the exemplary embodiment according to FIG. 4, the guide elements EF are distributed at three positions along the circumferential surface C and between one contact element EK and the next. Due to the guide elements EF, an axial offset between the shaft grounding device E and the shaft Wis limited, such that the contact elements EK are prevented from folding over during the mounting of the shaft grounding device E.

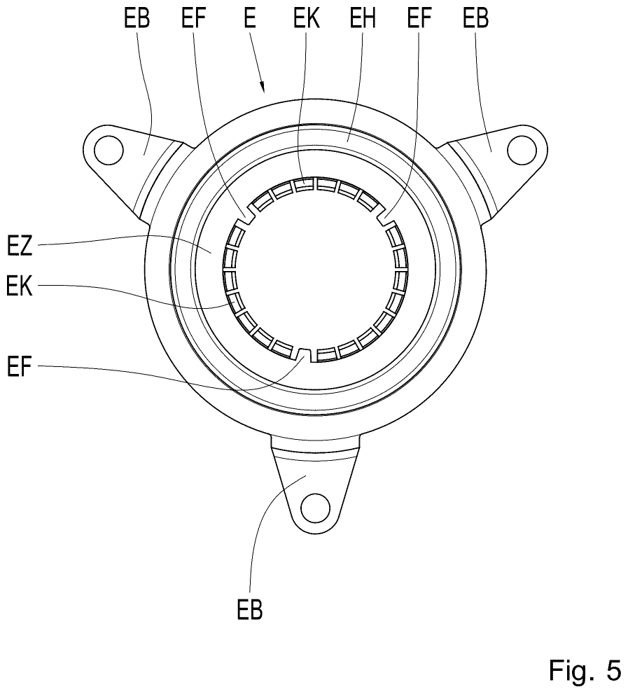

FIG. 5 shows a top view of the shaft grounding device E. In this view, the three positions of the guide elements EF and the ring-shaped arrangement of the contact elements EK are clearly apparent.

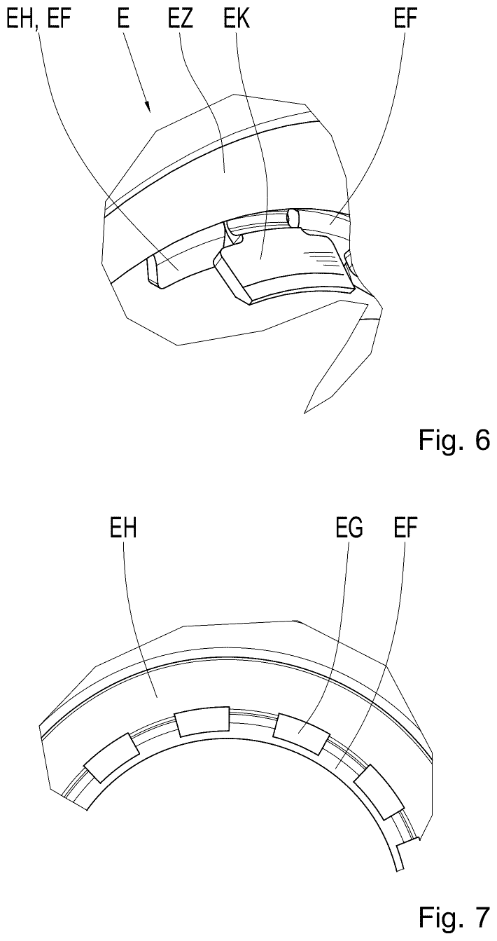

FIG. 6 shows a detailed view of the shaft grounding device E according to one further exemplary embodiment. In comparison to the exemplary embodiment shown in FIG. 4 and FIG. 5, the contact elements EK have a wider cross-section in the contact region with the shaft W than in the contact region with the holding element EH or with the clamping element EZ. Guide elements EF are arranged directly next to the contact region of the contact elements EK with the holding element EH, the guide elements EF being formed on the holding element EH in the indicated exemplary embodiment. The guide elements EF are formed as radially inwardly oriented projections. If the shaft grounding device E in the exemplary embodiment according to FIG. 6 were slid onto the shaft W counter to the target alignment, a deflection of the contact elements EK would be limited. This is the case because the contact elements EK could be bent only up to the point at which they stop at the guide elements EF.

FIG. 7 shows a detailed view of the shaft grounding device E according to one further exemplary embodiment, wherein only a portion of the holding element EH of the shaft grounding device E is shown. Instead of the radially inwardly oriented projections according to the exemplary embodiment shown in FIG. 6, the guide element EF is ring-shaped. Recesses EG are provided in the holding element EH in order to provide a sufficiently large free space for the contact elements EK.

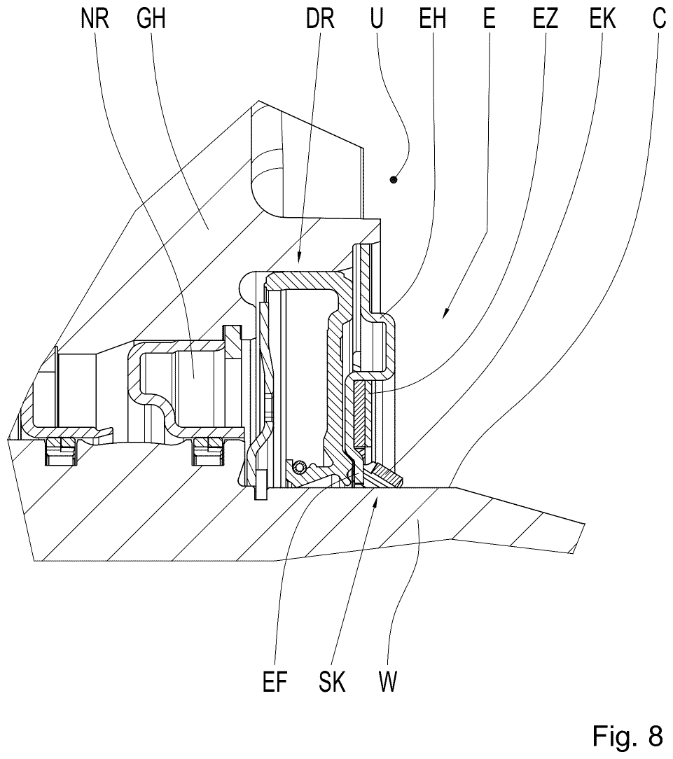

FIG. 8 shows a detailed sectional view of the shaft grounding device E together with the shaft W and the housing GH. In the present exemplary embodiment, the shaft grounding device E is arranged axially directly next to a radial shaft seal DR which seals a wet space NR with respect to the surroundings U. The shaft grounding device E is arranged on the surroundings side U of the radial shaft seal DR. The holding element EH is shown only in sections; the fastening tabs EB are not visible in FIG. 8. In the representation according to FIG. 8, the sliding contact SK between the contact elements EK and the circumferential surface C of the shaft W is clearly visible. In the exemplary embodiment according to FIG. 8, the guide element EF is an integral part of the holding element EH. There is a gap between the inner diameter of the guide element EF and the circumferential surface C, such that the guide element EF does not slide on the shaft W.

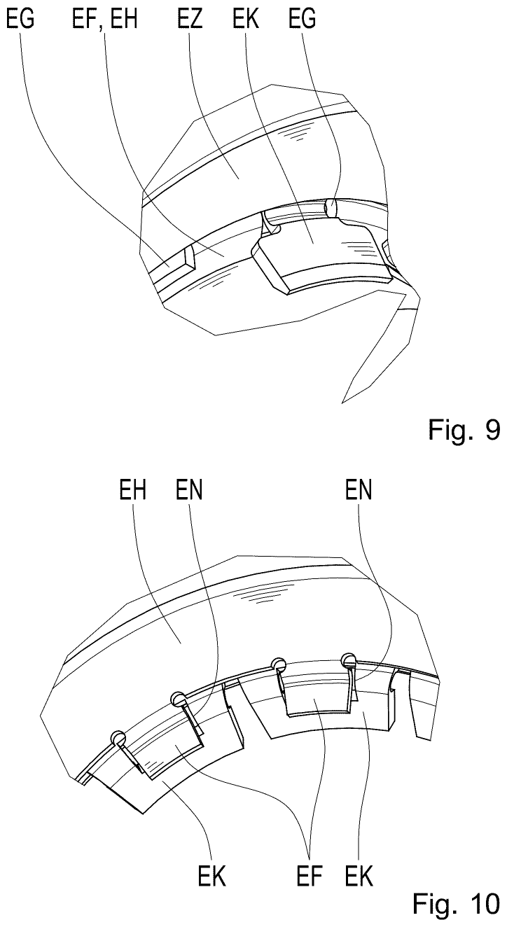

FIG. 9 shows a detailed view of the shaft grounding device E which has a ring-shaped guide element EF formed on the holding element EH. Recesses EG are provided in the holding element EH in order to ensure that there is sufficient open space for the elastic bending region of the contact elements EK.

FIG. 10 shows a detailed view of the shaft grounding device E according to one further exemplary embodiment. In this exemplary embodiment, the contact elements EK each have two bending sections at which the contact elements EK are connected to the holding element EH. The contact elements EK have a recess EN between these two bending sections. The contact elements EK each encompass one of the guide elements EF which are arranged in the region of the recesses EN. In this exemplary embodiment, the guide elements EF are formed as radially inwardly oriented projections which are arranged on the holding element EH.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

VM internal combustion engine
EX electric axle drive unit
G transmission
GW1 input shaft
GW2 output shaft
RS gear set
RS2 reduction gear set
EM electric machine
INV power inverter
BAT battery
AG differential gear
DS1 output shaft
DS2 output shaft
DW driving wheel
GA housing
EM2 electric machine
S stator
R rotor
RW rotor shaft
WL1 bearing
WL2 bearing
DR2 sealing ring
GE housing
E shaft grounding device
SK sliding contact
EH holding element
EG recess
EN recess
EB fastening tab
EZ clamping element
EK contact element
EF guide element
W shaft
C circumferential surface
DR radial shaft seal
U surroundings
NR wet space
GH housing

1-14: (canceled)

15. A shaft grounding device (E) for electrically conductively connecting a rotatable shaft (W) and a housing (GH), the shaft grounding device (E) being mechanically and electrically connected to the housing (GH), the shaft grounding device (E) comprising:
contact elements (EK), each of the contact elements (EK) being elastically bendable and electrically conductive, the contact elements (EK) forming a sliding contact (SK) that is electrically conductive with a circumferential surface (C) of the rotatable shaft (W) or a sleeve on the rotatable shaft (W), the contact elements (EK) preloading the sliding contact (SK); and
at least one guide element (EF), each of the at least one guide element (EF) preventing the contact elements (EK) from folding over when the shaft grounding device (E) is mounted onto the rotatable shaft (W).

16. The shaft grounding device (E) of claim 15, wherein the contact elements (EK) are arranged in a ring shape, wherein the at least one guide element (EF) comprises three guide elements (EF) spaced apart, each of the three guide elements (EF) being positioned between a respective pair of adjacent contact elements of the contact elements (EK).

17. The shaft grounding device (E) of claim 15, wherein the contact elements (EK) are arranged in a ring shape, wherein the at least one guide element (EF) is ring-shaped.

18. The shaft grounding device (E) of claim 15, further comprising:
a holding element (EH); and
a clamping element (EZ),
wherein the contact elements (EK) are held between the holding element (EH) and the clamping element (EZ), and
wherein the at least one guide element (EF) is formed on or fastened to the holding element (EH) or the clamping element (EZ).

19. The shaft grounding device (E) of claim 18, wherein the holding element (EH) or the clamping element (EZ) defines at least one recess (EG) for receiving at least one of the contact elements (EK).

20. The shaft grounding device (E) of claim 15, wherein at least one of the contact elements (EK) has a cross-section which increases radially inwardly and axial overlaps one or more of the at least one guide element (EF).

21. The shaft grounding device (E) of claim 15, wherein at least one of the contact elements (EK) encompasses one or more of the at least one guide element (EF).

22. The shaft grounding device (E) of claim 21, wherein each of the at least one of the contact elements (EK) defines a recess (EN), the one or more of the at least one guide element (EF) passing through the recess (EN).

23. The shaft grounding device (E) of claim 15, wherein the at least one guide element (EF) has no contact with the circumferential surface (C) when the shaft grounding device (E) is mounted onto the rotatable shaft (W).

24. A transmission (G) for a motor vehicle, comprising:
a housing (GG);
a shaft (GW2) mounted in the housing (GG); and
the shaft grounding device (E) of claim 15, the shaft grounding device (E) grounding the shaft (GW2).

25. The transmission (G) of claim 24, wherein the shaft (GW2) forms an output shaft of the transmission (G).

26. The transmission (G) of claim 24, further comprising an electric machine (EM), the shaft (GW2) being driveable by the electric machine (EM).

27. An electric axle drive unit (EX) for a motor vehicle, the electric axle drive unit (EX) comprising:
a housing (GA);
a shaft (DS1, DS2) mounted in the housing (GA); and
the shaft grounding device (E) of claim 15, the shaft grounding device (E) grounding the shaft (DS1, DS2).

28. An electric machine (EM2), comprising:
a housing (GE);
a rotationally fixed stator (S);
a rotatable rotor (R) coupled to a rotor shaft (RW), the rotor shaft (RW) being mounted in the housing (GE); and
the shaft grounding ring (E) of claim 15, the shaft grounding device (E) grounding the rotor shaft (RW).
